(19) United States
(12) Patent Application Publication
(10) Pub. No.: US 2014/0354075 A1
(43) Pub. Date: Dec. 4, 2014

(54) ELECTRIC POWER TRANSMISSION SYSTEM AND POWER TRANSMISSION DEVICE

(71) Applicant: MURATA MANUFACTURING CO. LTD., Nagaokakyo-shi (JP)

(72) Inventors: Tsuyoshi Suesada, Nagaokakyo-shi (JP); Shinji Goma, Nagaokakyo-shi (JP); Akihiko Shibata, Nagaokakyo-shi (JP)

(21) Appl. No.: 14/463,842

(22) Filed: Aug. 20, 2014

Related U.S. Application Data
(63) Continuation of application No. PCT/JP2012/079919, filed on Nov. 19, 2012.

(30) Foreign Application Priority Data
Mar. 7, 2012 (JP) 2012-049996

(51) Int. Cl. H02J 5/00

(52) U.S. Cl. CPC H02J 5/005
USPC 307/104

(57) ABSTRACT

A power reception device includes power reception electrodes which establish electric field coupling with power transmission electrodes provided in a power transmission device; and a transformer and rectification circuit which supply electric power based on the electric field excited by the power reception electrodes to a load. The power reception electrodes and the transformer form a parallel resonant circuit. The power transmission device includes a transformer which generates AC voltage to be applied to the power transmission electrodes; and a table in which correspondences between a plurality of resonant frequencies and a plurality of rated powers are described. The power transmission device sweeps the frequency of a PWM signal and detects the resonant frequency of the parallel resonant circuit, identifies a rated power corresponding to the detected resonant frequency based on the table, and adjusts the duty ratio of the PWM signal to match the identified rated power.

### CROSS REFERENCE TO RELATED APPLICATIONS

The present application is a continuation of PCT/JP2012/079919 filed Nov. 19, 2012, which claims priority to Japanese Patent Application No. 2012-049996, filed Mar. 7, 2012, the entire contents of each of which are incorporated herein by reference.

### FIELD OF THE INVENTION

The present invention relates to an electric power transmission system, and particularly, to an electric power transmission system which transmits, using an electric field and/or a magnetic field, electric power from a power transmission device to a power reception device.

The present invention also relates to a power transmission device, and a power transmission device which is applied to the electric power transmission system described above.

### BACKGROUND OF THE INVENTION

An example of an electric power transmission system of this type is disclosed in Patent Document 1. According to this related art, in general, at the time of authentication before starting power transmission, authentication information (a start code, a maker ID, a product ID, rated power information, resonance characteristics information, etc.) is transmitted from a power reception device to a power transmission device. The power transmission device carries out apparatus authentication and adjusts the maximum transmission power to match the rated power of the power reception device. In general, power transmission is performed after the power adjustment mentioned above is completed.

Patent Document 1: Japanese Unexamined Patent Application Publication No. 2008-206233

However, in the related art, there is a need to carry out authentication processing between the power transmission device and the power reception device in order to obtain rated power information, and furthermore, electric power needs to be supplied to the power reception device as a prerequisite of the authentication processing. Therefore, in the related art, the circuit configuration may be complicated.

### SUMMARY OF THE INVENTION

Accordingly, a main object of the present invention is to provide an electric power transmission system and a power transmission device which are capable of properly controlling electric power to be supplied to a load while a circuit configuration being simplified.

An electric power transmission system according to the present invention is an electric power transmission system which is formed of a power transmission device that includes exciting means for exciting an electric field and/or a magnetic field based on AC voltage; and a power reception device that includes resonant means for exhibiting a resonant frequency corresponding to a rated power, and supply means for supplying electric power based on the electric field and/or magnetic field excited by the exciting means to a load. The power transmission device further includes holding means for holding correspondences between a plurality of resonant frequencies and a plurality of rated powers; detecting means for sweeping a frequency of the AC voltage and detecting a resonant frequency of the resonant means; identifying means for identifying a rated power corresponding to the resonant frequency detected by the detecting means by referring to the correspondences held by the holding means; and adjusting means for adjusting a magnitude of the electric field and/or magnetic field excited by the exciting means to match the rated power identified by the identifying means.

Preferably, the exciting means includes a plurality of first electrodes to which the AC voltage is applied, the resonant means includes a plurality of second electrodes which establish electric field coupling with the plurality of first electrodes, and a first inductor to which AC voltage excited by the plurality of second electrodes is applied, and the supply means includes a second inductor which is inductively coupled with the first inductor.

Preferably, the detecting means includes changing means for repeatedly changing the frequency of the AC voltage, measuring means for measuring an impedance concurrently with processing of the changing means, and determining means for determining, as the resonant frequency of the resonant means, a frequency corresponding to a maximum value of the impedance measured by the measuring means from among a plurality of frequencies specified by the changing means.

According to an aspect, the power transmission device further includes current supply means for supplying current, and switching means for periodically switching, in order to generate the AC voltage, conduction of the current supplied by the current supply means, and the measuring means refers to voltage of an output terminal of the current supply means to measure the impedance.

According to another aspect, when the impedance measured by the measuring means has a plurality of maximum values, the determining means determines a frequency corresponding to a maximum value on a higher frequency side as the resonant frequency.

Preferably, the adjusting means includes voltage adjusting means for adjusting a level of the AC voltage.

Preferably, the power transmission device further includes generating means for generating the AC voltage by electromagnetic induction, and the adjusting means includes certain adjusting means for adjusting electromagnetic induction characteristics of the generating means.

Preferably, the resonant frequency of the resonant means decreases as the rated power increases, and the correspondences held by the holding means correspond to relationships in which a higher resonant frequency is associated with a lower rated power.

A power transmission device according to the present invention is a power transmission device which is coupled with a power reception device that includes resonant means for exhibiting a resonant frequency corresponding to a rated power, and supply means for supplying electric power based on an excited electric field and/or an excited magnetic field to a load. The power transmission device includes exciting means for exciting an electric field and/or a magnetic field based on AC voltage; holding means for holding correspondences between a plurality of resonant frequencies and a plurality of rated powers; detecting means for sweeping a frequency of the AC voltage and detecting a resonant frequency of the resonant means; identifying means for identifying a rated power corresponding to the resonant frequency detected by the detecting means by referring to the correspondences held by the holding means; and adjusting means for adjusting a magnitude of the electric field and/or magnetic field excited by the exciting means to match the rated power identified by the identifying means.

According to the present invention, resonant means provided in a power reception device is designed to exhibit a resonant frequency corresponding to the rated power of the power reception device. Therefore, resonant means of a power reception device having a certain rated power exhibits a certain resonant frequency, and resonant means of a power reception device having a different rated power exhibits a different resonant frequency. Holding means holds correspondences between such rated powers and resonant frequencies.

In view of the points described above, a power transmission device detects the resonant frequency of resonant means provided in a power reception device with which the power transmission device is coupled, and identifies a rated power corresponding to the detected resonant frequency by referring to the correspondences held by the holding means. Through this, electric power to be supplied to a load may be properly controlled while a circuit configuration being simplified.

The above described object, other objects, features, and advantages of the present invention will become more apparent from the following detailed description of embodiments with reference to the accompanying drawings.

### BRIEF DESCRIPTION OF DRAWINGS

FIG. 1 is a block diagram illustrating a configuration according to an embodiment of the present invention.

FIG. 2 is an illustration of an example of an external appearance of the embodiment illustrated in FIG. 1.

FIG. 3 is an illustration of an example of the configuration of a table referred to by a power transmission device according to the embodiment illustrated in FIG. 1.

FIG. 4 is a graph illustrating an example of a change in an impedance relative to a frequency.

FIG. 5 is a flowchart illustrating a part of an operation of a CPU used in the embodiment illustrated in FIG. 1.

FIG. 6 is a flowchart illustrating another part of the operation of the CPU used in the embodiment illustrated in FIG. 1.

FIG. 7 is a block diagram illustrating a part of the configuration of a power transmission device used in another embodiment of the present invention.

FIG. 8 is a flowchart illustrating a part of an operation of a CPU used in the embodiment illustrated in FIG. 7.

FIG. 9 is a block diagram illustrating a part of the configuration of a power transmission device used in another embodiment of the present invention.

FIG. 10 is a flowchart illustrating a part of an operation of a CPU used in the embodiment illustrated in FIG. 9.

FIG. 11 is a block diagram illustrating a configuration according to still another embodiment of the present invention.

FIG. 12 is an illustration of an example of the configuration of a table referred to by a power transmission device according to another embodiment.

FIG. 13 is a flowchart illustrating a part of an operation of a CPU used in a power transmission device according to another embodiment.

### DETAILED DESCRIPTION OF THE PREFERRED EMBODIMENTS

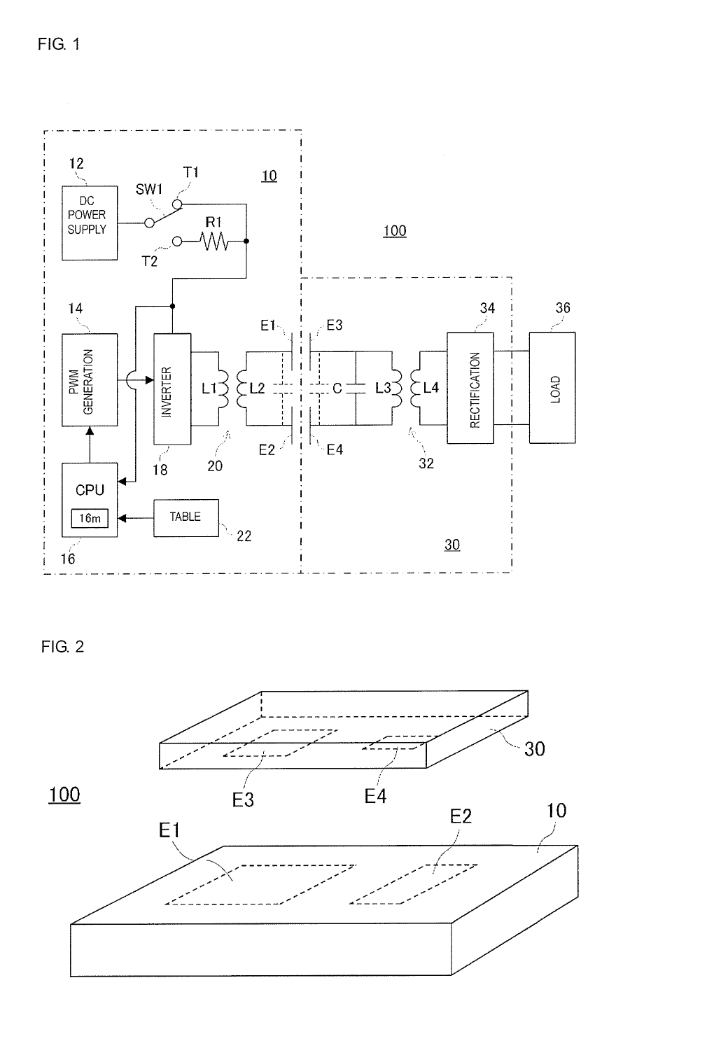

Referring to FIGS. 1 and 2, an electric power transmission system 100 according to an embodiment is formed of a power transmission device 10 having an upper surface in which power transmission electrodes E1 and E2 are embedded, and a power reception device 30 having a lower surface in which power reception electrodes E3 and E4 are embedded. When the lower surface of the power reception device 30 is made closer to the upper surface of the power transmission device 10 so that the power reception electrodes E3 and E4 face the power transmission electrodes E1 and E2 (see FIG. 2), electric field coupling occurs between the power reception device 30 and the power transmission device 10. Therefore, electric power of the power transmission device 10 is transmitted to the power reception device 30.

As illustrated in FIG. 1, a DC power supply 12 applies DC voltage to an input terminal of a switch SW1 which is connected to one of terminals T1 and T2. The terminal T1 is directly connected to an inverter 18, and the terminal T2 is connected to the inverter 18 via a resistor R1. Accordingly, connecting the switch SW1 with the terminal T1 causes DC voltage to be supplied to the inverter 18, and connecting the switch SW1 with the terminal T2 causes voltage dropped through the resistor R1 to be supplied to the inverter 18.

The inverter 18 is in an ON state during a period in which a PWM signal output from a PWM generation circuit 14 indicates H level, and is in an OFF state during a period in which a PWM signal output from the PWM generation circuit 14 indicates L level. The inverter 18 is also connected to an inductor L1, which is one of inductors L1 and L2 which form a transformer 20 and which are inductively coupled with each other.

Accordingly, when the inverter 18 is turned on/off in the manner described above, AC voltage is induced in each of the inductors L1 and L2. Here, the number of windings in the inductor L2 is greater than the number of windings in the inductor L1, and the AC voltage inducted in the inductor L2 is higher than the AC voltage induced in the inductor L1. Furthermore, the frequency and level of the AC voltage induced in each of the inductors L1 and L2 depend on the frequency and the duty ratio of a PWM signal, respectively.

The AC voltage inducted in the inductance L2 is applied to the power transmission electrodes E1 and E2. An AC voltage having a frequency corresponding to the frequency of the applied AC voltage and a level depending on the degree of electric field coupling is excited in the power reception electrodes E3 and E4 which establish electric field coupling with the power transmission electrodes E1 and E2.

The AC voltage excited as described above is supplied to a rectification circuit 34 via inductors L3 and L4 which form a transformer 32 and which are inductively coupled with each other. Here, the number of windings in the inductor L4 is smaller than the number of windings in the inductor L3, and AC voltage supplied to the rectification circuit 34 is lower than the AC voltage excited in the power reception electrodes E3 and E4. The rectification circuit 34 rectifies such an AC voltage into a DC voltage, and supplies the rectified DC voltage to a load 36.

A parallel resonant circuit including a capacitance C and an inductor L3 is provided in the power reception device 30 of the electric power transmission system 100 illustrated in FIG. 1. The resonant frequency of the parallel resonant circuit is defined by Equation 1.

Fpr=1/(2π√(L3*C) Equation 1:

Fpr: resonant frequency of parallel resonant circuit

In the electric power transmission system 100 according to this embodiment, the characteristics of the capacitance C and the inductance L3 (that is, the characteristics of the power reception electrodes E3 to E4 and the transformer 32) are adjusted so that the resonant frequency Fpr varies according to the rated power of the power reception device 30.

More specifically, when the rated power of the power reception device 30 is 1 W, the characteristics of the capacitance C and the inductance L3 are adjusted so that the resonant frequency Fpr falls within the range from a frequency f1 to a frequency f2. Further, when the rated power of the power reception device 30 is 3 W, the characteristics of the capacitance C and the inductance L3 are adjusted so that the resonant frequency Fpr falls within the range from the frequency f2 to a frequency f3.

Furthermore, when the rated power of the power reception device 30 is 5 W, the characteristics of the capacitance C and the inductance L3 are adjusted so that the resonant frequency Fpr falls within the range from the frequency f3 to a frequency f4. Furthermore, when the rated power of the power reception device 30 is 7 W, the characteristics of the capacitance C and the inductance L3 are adjusted so that the resonant frequency Fpr falls within the range from the frequency f4 to a frequency f5.

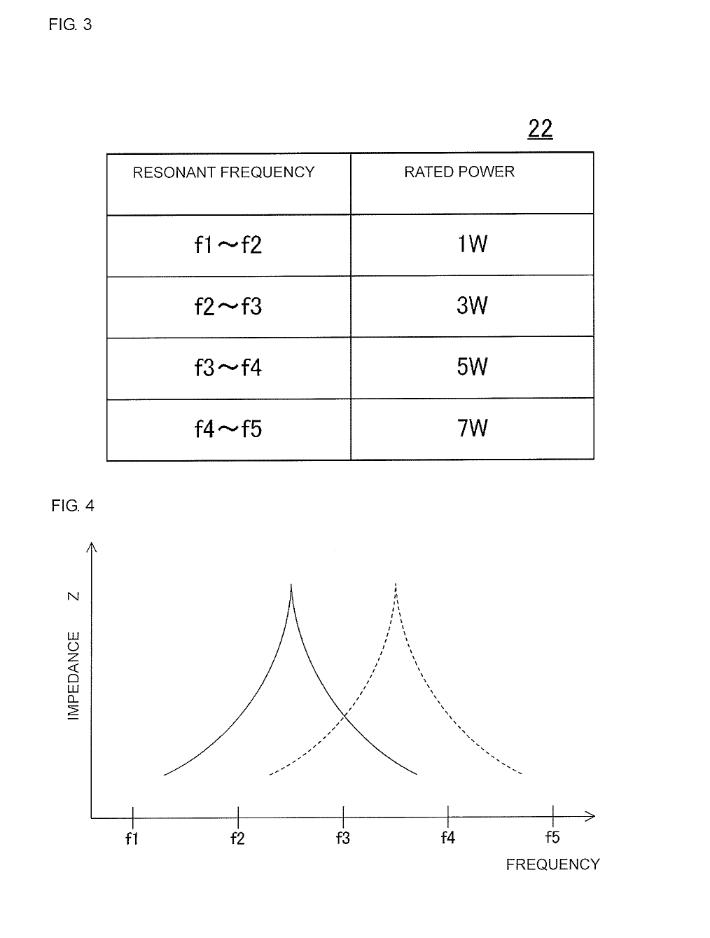

The above-mentioned relationship between the resonant frequency Fpr and the rated power is registered in a table 22 provided in the power transmission device 10, in a manner illustrated in FIG. 3. When starting power supply to the power reception device 30 which establishes electric field coupling with the power transmission device 10, a CPU 16 provided in the power transmission device 10 refers to the table 22 to identify the rated power of the power reception device 30, and controls the operation of the PWM generation circuit 14 to match the identified rated power.

More specifically, the CPU 16 first changes the connection destination of the switch SW1 from the terminal T1 to the terminal T2, sets the duty ratio of a PWM signal to a constant value, and sweeps the frequency of the PWM signal from “f1” to “f5”.

The PWM generation circuit 14 supplies a PWM signal having the duty ratio and frequency defined as described above to the inverter 18. Accordingly, an AC voltage having the level and frequency depending on the duty ratio and frequency is applied to the power transmission electrodes E1 to E2, and an impedance Z is also measured based on the voltage of the input terminal of the inverter 18.

When a power reception device 30 having a rated power of 3 W establishes electric field coupling with the power transmission device 10, the impedance Z exhibits frequency characteristics expressed by the solid line in FIG. 4. In contrast, when a power reception device 30 having a rated power of 5 W establishes electric field coupling with the power transmission device 10, the impedance Z exhibits frequency characteristics expressed by the dotted line in FIG. 4.

The CPU 16 detects, as the resonant frequency Fpr, a frequency at which the measured impedance Z exhibits the maximum value, and identifies the rated power of the power reception device 30 by comparing the detected frequency with a description in the table 22. As a result, the rated power of 3 W is identified correspondingly to the frequency characteristics expressed by the solid line in FIG. 4, and the rated power of 5 W is identified correspondingly to the frequency characteristics expressed by the dotted line in FIG. 4.

When the rated power is specified, the CPU 16 sets the frequency of the PWM signal to the resonant frequency Fpr, and adjusts the duty ratio of the PWM signal to match the rated power. Then, the switch SW1 is re-connected to the terminal T1. Accordingly, power supply to the power reception device 30 starts.

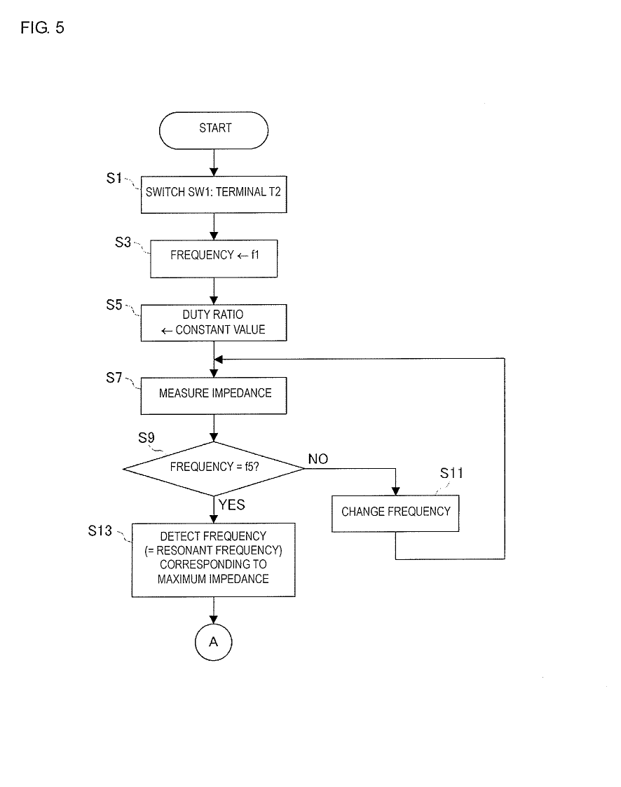

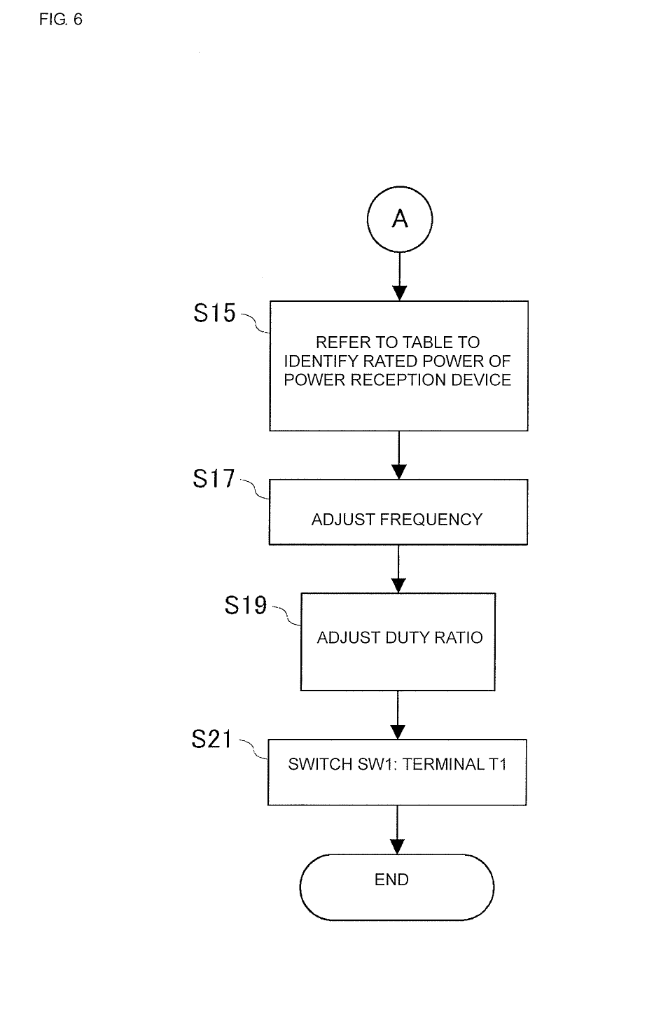

Specifically, the CPU 16 performs a process based on flowcharts illustrated in FIGS. 5 to 6. A control program corresponding to the flowcharts is stored in a flash memory 16m.

Referring to FIG. 5, in step S1, the connection destination of the switch SW1 is changed from the terminal T1 to the terminal T2. In step S3, the frequency of a PWM signal is set to “f1”. In step S5, the duty ratio of the PWM signal is set to a constant value. The PWM generation circuit 14 supplies the PWM signal having the set frequency and duty ratio to the inverter 18.

In step S7, the impedance Z is measured based on the voltage of the input terminal of the inverter 18. In step S9, it is determined whether or not the set frequency has reached “f5”. When the result of the determination is NO, the set frequency is widened by a specified range in step S11. Then, the process returns to step S7. Accordingly, the frequency characteristics of the impedance Z in the range from the frequency f1 to the frequency f5 become clear.

When the result of the determination in step S9 is YES, the process proceeds to step S13. In step S13, the frequency at which the impedance Z exhibits the maximum value is detected as the resonant frequency Fpr. In step S15, the detected frequency is compared with the table 22, and the rated power of the power reception device 30 is identified. In step S17, the frequency of the PWM signal is set to the resonant frequency Fpr. In step S19, the duty ratio of the PWM signal is adjusted to match the rated power identified in step S15. Once completing the adjustment, the switch SW1 is re-connected to the terminal T1 in step S21. Then, the process ends.

As is clear from the explanation provided above, the power reception device 30 includes the power reception electrodes E3 to E4 which establish electric field coupling with the power transmission electrodes E1 to E2 provided in the power transmission device 10; and the transformer 32 and the rectification circuit 34 which supply to the load 36 electric power based on an electric field excited in the power reception electrodes E3 to E4 by the electric field coupling. Here, the power reception electrodes E3 to E4 and the transformer 32 form a parallel resonant circuit. In contrast, the power transmission device 10 includes the transformer 20 that generates AC voltage to be applied to the power transmission electrodes E1 to E2; and the table 22 in which correspondences between a plurality of resonant frequencies and a plurality of rated powers are described. The CPU 16 of the power transmission device 10 sweeps the frequency of a PWM signal to detect the resonant frequency Fpr of the parallel resonant circuit, refers to a description in the table 22 to identify a rated power corresponding to the detected resonant frequency Fpr, and adjusts the duty ratio of the PWM signal to match the identified rated power.

The parallel resonant circuit provided in the power reception device 30 is designed to exhibit a resonant frequency corresponding to the rated power of the power reception device 30. Therefore, the resonant frequency Fpr of a parallel resonant circuit provided in a power reception device 30 having a certain rated power exhibits a certain value, and the resonant frequency Fpr of a parallel resonant circuit provided in a power reception device 30 having a different rated power exhibits a different value. The correspondences between such rated powers and resonant frequencies Fpr are described in the table 22.

In view of the points described above, the power transmission device 10 detects the resonant frequency Fpr of the parallel resonant circuit provided in the power reception device 30 with which the power transmission device 10 is coupled, and identifies a rated power corresponding to the detected resonant frequency Fpr by referring to the correspondences described in the table 22. Accordingly, electric power to be supplied to a load may be properly controlled while a circuit configuration being simplified.

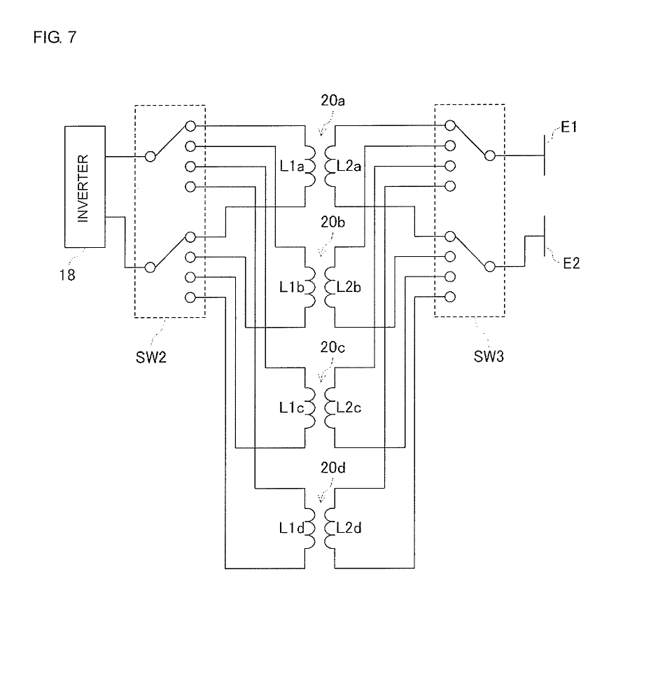

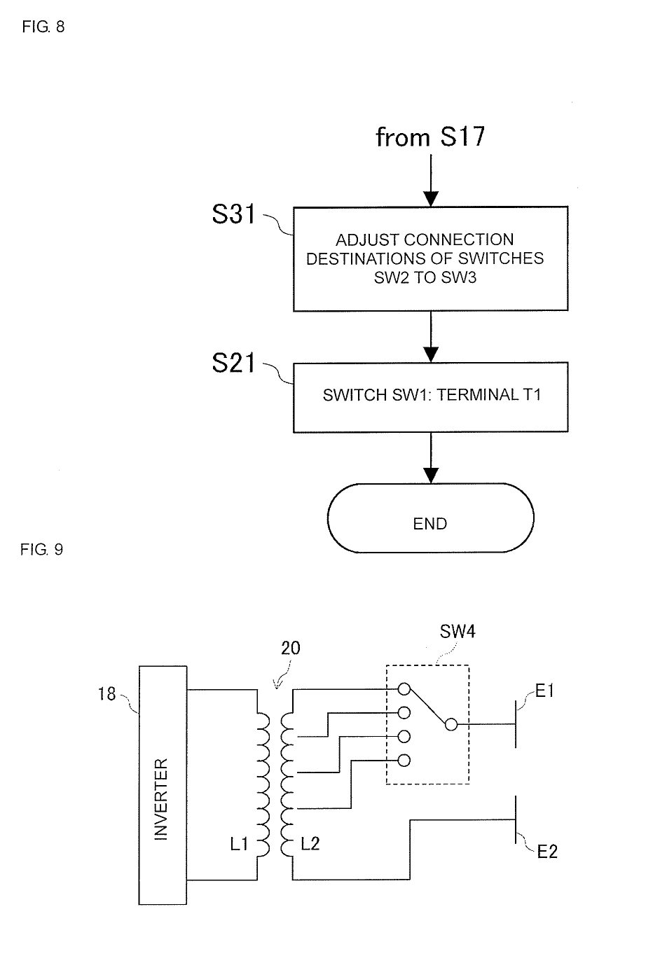

In this embodiment, the duty ratio of a PWM signal is adjusted so that the level of AC voltage applied to the power transmission electrodes E1 to E2 matches the rated power of the power reception device 30 (see step S19). However, by providing four transformers 20a to 20d corresponding to 1 W, 3 W, 5 W, and 7 W, respectively, and switches SW2 and SW3 for controlling connection of the transformers 20a to 20d, instead of the transformer 20, in the power transmission device 10 (see FIG. 7), connection of the switches SW2 and SW3 may be adjusted to match the rated power of the power reception device 30. In this case, instead of step S19 illustrated in FIG. 6, step S31 for adjusting connection of the switches SW2 and SW3 needs to be performed (see FIG. 8).

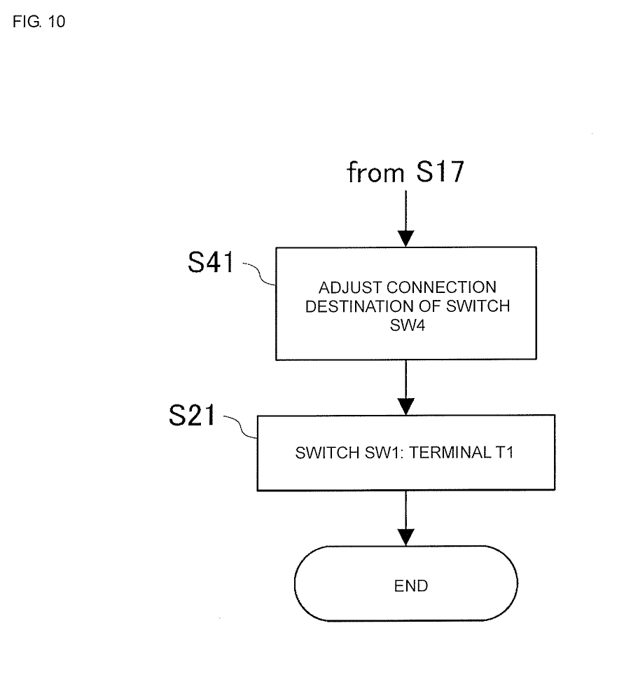

Furthermore, by connecting four output terminals corresponding to 1 W, 3 W, 5 W, and 7 W, respectively, and a switch SW4 for selecting one of the output terminals with the inductor L2 of the transformer 20(see FIG. 9), connection of the switch SW4 may be adjusted to match the rated power of the power reception device 30. In this case, instead of step S19 illustrated in FIG. 6, step S41 for adjusting connection of the switch SW4 needs to be performed (see FIG. 10).

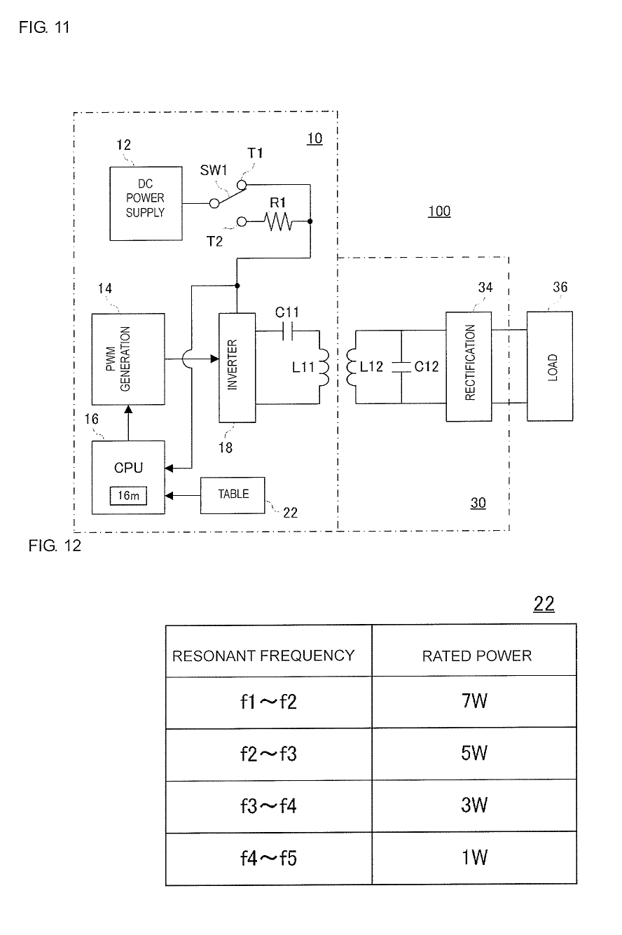

Moreover, although an electric power transmission system utilizing an electric field coupling method is assumed in this embodiment, the present invention is also applicable to an electric power transmission system utilizing an inductive coupling method illustrated in FIG. 11. Referring to FIG. 11, a capacitor C11 and an inductor L11 are connected in series to the inverter 18, an inductor L12 and a capacitor C12 are connected in parallel to the rectification circuit 34, and AC voltage is transmitted via the inductors L11 and L12.

Furthermore, in the embodiments illustrated in FIGS. 1 to 10, the resonant frequency Fpr of the power reception device 30 is adjusted within the range from the frequency f1 to the frequency f2 correspondingly to a rated power of 1 W, within the range from the frequency f2 to the frequency f3 correspondingly to a rated power of 3 W, within the range from the frequency f3 to the frequency f4 correspondingly to a rated power of 5 W, and within the range from the frequency f4 to the frequency f5 correspondingly to a rated power of 7 W. Furthermore, correspondences between such resonant frequencies Fpr and rated powers are registered in the table 22 provided in the power transmission device 10 (see FIG. 3).

However, the frequency characteristics of the power reception device 30 may be adjusted so that the resonant frequency Fpr decreases as the rated power of the power reception device 30 increases, and such a correspondence between the resonant frequency Fpr and the rated power may be registered in the table 22.

In this case, the resonant frequency Fpr of the power reception device 30 is adjusted within the range from the frequency f1 to the frequency f2 correspondingly to the rated power of 7 W, within the range from the frequency f2 to the frequency f3 correspondingly to the rated power of 5 W, within the range from the frequency f3 to the frequency f4 correspondingly to the rated power of 3 W, and within the range from the frequency f4 to the frequency f5 correspondingly to the rated power of 1 W. Furthermore, the correspondences illustrated in FIG. 12 are registered in the table 22. Referring to FIG. 12, the rated power of 7 W is allocated to the frequencies f1 to f2, the rated power of 5 W is allocated to the frequencies f2 to f3, the rated power of 3 W is allocated to the frequencies f3 to f4, and the rated power of 1 W is allocated to the frequencies f4 to f5.

When a foreign substance is caught between the power transmission device 10 and the power reception device 30 or when the position of the power reception device 30 relative to the power transmission device 10 is displaced, the coupling capacity between the power transmission electrodes E1 to E2 and the power reception electrodes E3 to E4 decreases, thereby the resonant frequency Fpr being shifted towards higher frequencies. Thus, in the embodiments illustrated in FIGS. 1 to 10, electric power higher than the rated power of the power reception device 30 is falsely detected from the table 22 illustrated in FIG. 3. Therefore, supply of higher electric power may cause breakdown of the power reception device 30.

Therefore, in this embodiment, the table 22 illustrated in FIG. 12 is adopted, and the frequency characteristics of the power reception device 30 are adjusted so as to correspond to the table 22. Accordingly, breakdown of the power reception device 30 caused by false detection of rated power may be prevented.

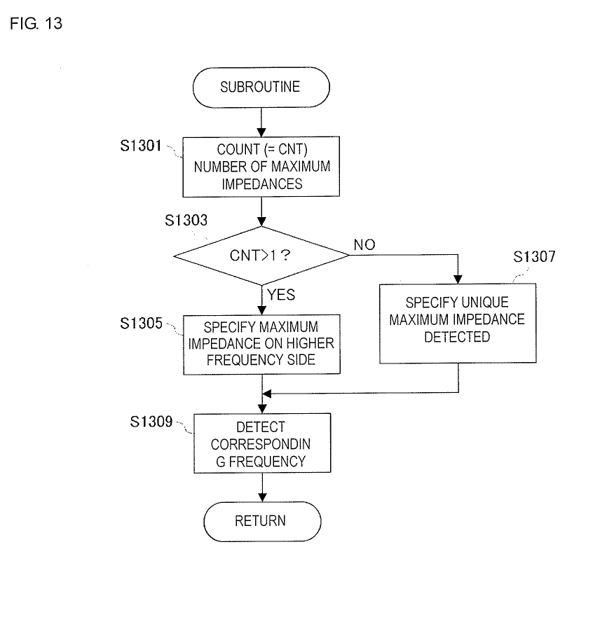

Furthermore, in the foregoing embodiments, it is assumed that the impedance Z measured by the processing of steps S3 to S11 illustrated in FIG. 5 exhibits only a maximum value corresponding to the resonant frequency of the power reception device 30. However, when the range of frequencies to be swept is expanded, in addition to the maximum value corresponding to the resonant frequency of the power reception device 30, a maximum value corresponding to the resonant frequency of the power transmission device 10 may appear in the impedance Z measured. Taking such a possibility into consideration, in step S13 illustrated in FIG. 5, processing according to a subroutine illustrated in FIG. 13 needs to be performed.

Referring to FIG. 13, in step S1301, a maximum value, that is, a maximum impedance, is detected from the impedance Z measured by the processing of steps S3 to S13, and the number of maximum impedances detected is set as a variable CNT. In step S1303, it is determined whether or not the variable CNT exceeds “1”. When the determination result is YES, the process proceeds to step S1305. In contrast, when the determination result is NO, the process proceeds to step S1307.

In step S1305, the maximum impedance at the highest frequency is specified from among a plurality of maximum impedances detected. In step S1307, the unique maximum impedance detected is specified. When the processing of step S1305 or S1307 is completed, the process proceeds to step S1309. In step S1309, a frequency corresponding to the specified maximum impedance is detected as the resonant frequency Fpr. When detection of the resonant frequency Fpr is completed, the process returns to a higher-level routine.

The present invention has been described and illustrated in detail. However, it is clearly understood that the description and illustration are provided by way of merely illustration and example and are not provided by way of limitation. The spirit and scope of the present invention is limited only by the terms of the appended claims.

### REFERENCE SIGNS LIST

10 . . . power transmission device
14 . . . PWM generation circuit
16 . . . CPU
18 . . . inverter
20, 32 . . . transformer
22 . . . table
34 . . . rectification circuit
E1 to E2 . . . power transmission electrode
E3 to E4 . . . power reception electrode

1. An electric power transmission system comprising:
a power reception device including:
a parallel resonant circuit that exhibits a resonant frequency, and
a supply circuit that supplies electric power to a load; and
a power transmission device including:
a power supply circuit that generates a current,
a plurality of first electrodes that excite at least one of an electric field and a magnetic field based on an AC voltage generated from the current,
electronic memory that stores a plurality of rated power levels that correspond to a plurality of resonant frequencies, respectively,
a detecting circuit that sweeps a frequency of the AC voltage and detects the resonant frequency exhibited by the parallel resonant circuit, and
a processor configured to:
identify a rated power level of the power reception device based on one of the plurality of rated power levels stored in the electronic memory that corresponds to the detected resonant frequency, and
adjust a magnitude of the at least one of the electric field and the magnetic field based on the identified rated power level.

2. The electric power transmission system according to claim 1,
wherein the parallel resonant circuit includes a first inductor and a plurality of second electrodes that electrically couple with the plurality of first electrodes and that excite an AC voltage in the first inductor, and
wherein the supply circuit includes a second inductor inductively coupled with the first inductor.

3. The electric power transmission system according to claim 1, wherein the power transmission device further includes a transformer that is coupled to plurality of first electrodes and that increases the AC voltage.

4. The electric power transmission system according to claim 3, wherein the processor is further configured to measure an impedance of the transformer during the frequency sweep of the AC voltage, and determine the detected resonant frequency exhibited by the parallel resonant circuit to be a frequency of the AC voltage when the impedance has a maximum value during the frequency sweep.

5. The electric power transmission system according to claim 4,
wherein the power supply circuit of the power transmission device further includes a switch that periodically switches conduction of a current supplied by the power supply circuit to generate the AC voltage, and
wherein the impedance is measured at an output terminal of the power supply circuit coupled to the transformer.

6. The electric power transmission system according to claim 4, wherein when the measured impedance has a plurality of maximum values, the processor determines a frequency corresponding to a maximum value on a higher frequency side as the resonant frequency exhibited by the parallel resonant circuit of the power receiving device.

7. The electric power transmission system according to claim 1,
wherein the power transmission device further includes a PWM generation circuit configured to control the AC voltage supplied to the plurality of first electrodes, and
wherein the processor is further configured to adjust a duty cycle of the PWM generation circuit to adjust a level of the AC voltage.

8. The electric power transmission system according to claim 3, wherein the power supply circuit supplies the current to the transformer that generates the AC voltage by electromagnetic induction.

9. The electric power transmission system according to claim 1, wherein the plurality of rated power levels stored in the electronic memory increase in correspondence to the plurality of resonant frequencies.

10. A power transmission device for transmitting power to a power reception device that exhibits a resonant frequency in response to an AC voltage transmitted by the power transmission device, the power transmission device comprising:
a power supply circuit that generates a current;
a transformer configured to generate the AC voltage based from the current;
a plurality of first electrodes coupled to the transformer that excite at least one of an electric field and a magnetic field based on the AC voltage;
electronic memory that configured to store a plurality of rated power levels that correspond to a plurality of resonant frequencies, respectively;
a detecting circuit configured to detect the resonant frequency exhibited by the power reception device in response to the AC voltage; and
a processor configured to:
identify a rated power level of the power reception device based on one of the plurality of rated power levels stored in the electronic memory that corresponds to the detected resonant frequency, and
adjust a magnitude of the at least one of the electric field and the magnetic field based on the identified rated power level.

11. The power transmission device according to claim 10, wherein the processor is further configured to:
measure an impedance of the transformer during a frequency sweep of the AC voltage, and
determine the detected resonant frequency exhibited by the power reception device to be a frequency of the AC voltage when the impedance has a maximum value during the frequency sweep.

12. The power transmission device according to claim 10,
wherein the power supply circuit of the power transmission device further includes a switch that periodically switches conduction of the current to generate the AC voltage, and
wherein the impedance is measured at an output terminal of the power supply circuit coupled to the transformer.

13. The power transmission device according to claim 12, wherein when the measured impedance has a plurality of maximum values, the processor determines a frequency corresponding to a maximum value on a higher frequency side as the resonant frequency exhibited by the parallel resonant circuit of the power receiving device.

14. The power transmission device according to claim 10 further comprising a PWM generation circuit configured to control the AC voltage supplied to the plurality of first electrodes, wherein the processor is further configured to adjust a duty cycle of the PWM generation circuit to adjust a level of the AC voltage.

15. The power transmission device according to claim 10, wherein the plurality of rated power levels stored in the electronic memory increase in correspondence to the plurality of resonant frequencies.

16. A method of transmitting power from a power transmission device to a power reception device that exhibits a resonant frequency in response to an AC voltage transmitted by the power transmission device, the method comprising:
exciting at least one of an electric field and a magnetic field based on an AC voltage;
detecting the resonant frequency exhibited by the power reception device in response to the AC voltage;
identifying a rated power level of the power reception device by comparing the detected resonant frequency to a plurality of rated power levels stored in an electronic; and
adjusting a magnitude of the at least one of the electric field and the magnetic field based on the identified rated power level of the power reception device.

17. The method according to claim 16, wherein the step of identifying the rated power level further comprises:
measuring an impedance during a frequency sweep of the AC voltage; and
determining the detected resonant frequency exhibited by the power reception device to be a frequency of the AC voltage when the impedance has a maximum value during the frequency sweep.

18. The method according to claim 17, wherein when the measured impedance has a plurality of maximum values, the identifying step further comprises determining a frequency corresponding to a maximum value on a higher frequency side as the resonant frequency exhibited by the parallel resonant circuit of the power receiving device.

19. The method according to claim 16, further comprising controlling the AC voltage by adjusting a duty cycle of a PWM generation circuit to adjust a level of the AC voltage.

20. The method according to claim 16, wherein the plurality of rated power levels stored in the electronic memory increase in correspondence to the plurality of resonant frequencies.
